(19) United States
(12) Patent Application Publication
(10) Pub. No.: US 2009/0214008 A1
(43) Pub. Date: Aug. 27, 2009

(54) METHOD AND SYSTEM FOR LOCATION BASED RING BACK TONES

(76) Inventor: Babu Mani, Murphy, TX (US)

Correspondence Address: ERICSSON INC., 6300 LEGACY DRIVE, M/S EVR 1-C-11, PLANO, TX, 75024, US

(21) Appl. No.: 12/035,122

(22) Filed: Feb. 21, 2008

(51) Int. Cl. H04M 1/64

(52) U.S. Cl. 379/88.23

(57) ABSTRACT

A method and system of providing ring back tone (RBT) content to a calling party, based on obtaining location based data related to a terminal, correlating the location based data to RBT content and providing the correlated RBT content to the calling party. The method and system is further adapted to apply rules selected by an RBT subscriber in connection with the provision of RBT content to a calling party. The RBT content is localized to the location of the called party. For example, the RBT content can be one selected from the group consisting of regional or local music, regional or local speech, regional or local news, regional or local events calendar, regional or local sports, regional or local weather, and regional or local time.

### BACKGROUND

The present invention relates to telecommunication systems. More particularly, and not by way of limitation, the present invention is directed to a method and system for providing a calling party with a ringback tone (RBT) based on the location of the called party. As used herein, the following abbreviations shall have the following meanings:

AT—Answer Tones

CRBT—Color Ringback Tone

GPS—Global Positioning System

LBA—Location Based Applications

MSC—Mobile Switching Center

RBT—Ringback Tone

SCP—Service Control Point

In a call made over a telecommunications system using a wireless infrastructure, wireline infrastructure or both, a calling party uses the telecommunication infastructure to signal a called party. The party that initiates the call is referred to as the caller or calling party, and the party receiving the call is referred to as the called party, terminating party or subscriber. As used herein, it is assumed that the subscriber and the called party are the same person.

RBT is a service provided to the subscribers of telecommunication service providers that enables the subscribers to substitute the regular audible ringing provided to a calling party with a tone or audio clip selected by the called party during the process of connecting a call. This service is also known as Color Ringback Tones (CRBT) and Answer Tones (AT). It is also possible to substitute the tone or the audio clip with other media content. Thus the RBT content presented to callers can be video, text, graphics, photos, etc., only limited by the capabilities of the caller's handset and the transmission capabilities of the telecommunications network. RBT is a terminating service. In other words, the terminating user is the called party who subscribes to the RBT service and callers listen to RBT content as specified by the subscriber who is the called party.

Currently, the RBT service selects a song as the RBT that is played to the calling party as statically determined by the RBT subscriber. In other words, the RBT is pre-assigned by the called party and may be based on certain parameters. Typically, such parameters include the identity of the caller, the time of day, and a random selection from a list of songs that the RBT subscriber has purchased.

Due to advances in positioning technologies, such as global positioning systems (GPS) and terrestrial triangulation techniques, there are being developed services based on the location of the parties to a telecommunications call. These services are generally known as location based applications (LBA). A first example is the use of an LBA to find the nearest business such as a restaurant to a caller and a second example it to obtain directions from the current location of the caller to a given location. However, conventionally, there is no association of the location of either the RBT subscriber or of the calling party when determining which RBT is provided to the calling party. What is desired is a method and system that associates the location of either the RBT subscriber or the calling party when determining which RBT is provided to the calling party.

### SUMMARY

When an RBT or AT subscriber travels to a different geographic location, they may find it desirable to add a flavor of their location to the calling party or cue to the calling party as to the location. The present invention is a method and system for location based RBT that is operable to provide a RBT subscriber the freedom to adapt RBT treatment as the subscriber travels to different locations. Whereas LBA are dependent on the location of the caller, in the present invention the location of the called party is used to adapt the RBT content. Because RBT is a terminating service, the called party determines the content of the RBT or AT. The present invention is adapted to provide an RBT subscriber with the ability to customize the RBT treatment provided to a caller, e.g. based on the called party's preferred location or the subscriber's current location as identified by the service provider using a location based mechanism. The present invention adapts RBT for use in a location based application.

### BRIEF DESCRIPTION OF THE SEVERAL VIEWS OF THE DRAWINGS

FIG. 1 is a flow chart of an embodiment of the method of the location based RBT treatment of the present invention; and

FIG. 2 is a block diagram of an embodiment of the system used to implement the present invention.

### DETAILED DESCRIPTION

The present invention provides a caller to a RBT subscriber content that has been requisitioned by the RBT subscriber, which content corresponds to the location of the subscriber, either as statically designated by the RBT subscriber or as dynamically detected by the network as the subscriber moves from one location to another. Such content is any content that can be associated with a specific location, including but not limited to regional or local music, regional or local speech, regional or local news, regional or local events calendar, regional or local sports, regional or local weather, and regional or local time.

A caller calling an RBT subscriber who has subscribed to the service implemented by the present invention will get a different RBT treatment if the RBT subscriber has moved to a different location. The location based content can include greeting in the local language (optionally to be followed by greeting in a language, e.g., English, as recorded by the subscriber) where the subscriber is traveling, to be followed by the local content. Further, the content can be spoken or provided in a local language. When provisioning, the subscriber can select the language for the local content or can provide to the calling party the option to select a language from an available list of languages for playing the RBT content. The RBT content is not limited to audio content, but can be any media which can be received and decoded by a terminal, such as a digital photograph or streaming video. The present invention can further provide the subscriber the option to: provide location based RBT treatment only to selected callers; provide recording with variables, which will be filled in by values appropriate to the identified location, for example, “Good Morning from”, <location name>; “the local time is”, <local time> which is then followed by selected location based content that is streamed to the caller; select a different RBT content based on the identification of the caller, for example, if the caller is a business partner, the party could select one RBT content and if a family member, another RBT content; turn on or off the location based RBT, for example, a subscriber can turn on the service only when the subscriber is traveling.

The present invention is a method and system for obtaining and transmitting location based data, e.g., from a GPS module in a terminal of either a caller or a called party, or both, or from a wireless system in which such terminal is in communication, to a functional node of a telecommunications system such as a service platform, an application server or service control point that implements RBT service. The location based data is then correlated with RBT content from the application server and a desired RBT content is provided to a calling party based on the location based data. Alternatively, the present invention is a node coupled to a telecommunication system, the node adapted to accept location based data from, or related to, a terminal of either a called party or a calling party, and, correlate such location based data to content that is provided as a RBT to a caller.

When the terminating exchange queries the application server, obtains the location based data and notifies or directs the terminating exchange as to what RBT content should be given to an incoming call. In this manner, the subscriber can specify the RBT content based on the either the calling party's or the subscriber's location. The service provided by the present invention can be provisioned by the subscriber, e.g., through an Internet portal, or by contacting the subscriber's service provider, who then sets up the service. During provisioning, the RBT content to be provided can be as selected by the subscriber, or can be selected by the service provider based on the location of the called party.

The present invention can be implemented on any server or service platform that implements RBT selection. The location based data can be either pushed or pulled from the local MSC. The embodiments described below are based on providing local content corresponding to the location of the called party, but the present invention is not necessarily limited to that context, as content based on the location of the calling party can also be implemented.

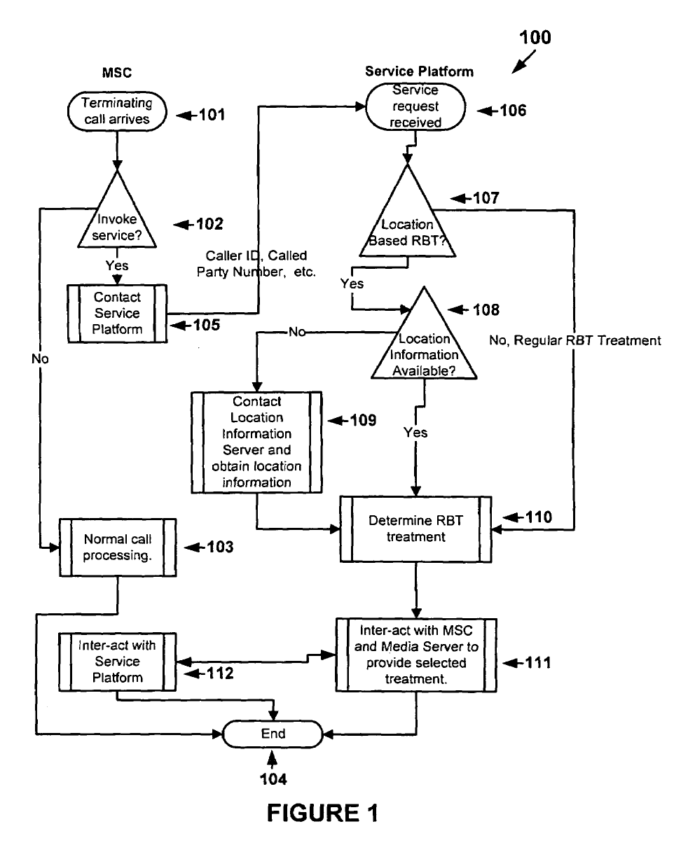

Referring to FIG. 1, a first embodiment of the present invention 100 is presented. As seen therein, a caller attempts to signal a called party and the call arrives at a terminating exchange at step 101. In step 102, a service platform determines whether a standard call treatment (e.g., based on the RBT) or call treatment based on the called party's location is to be invoked. If not, then in step 103, conventional call processing occurs and the method terminates at step 104. Alternatively, in step 102, an MSC could determine if LBA based RBT is to be invoked. In such case, the LBA based RBT treatment becomes a separate service. Also, in such case, the MSC would retrieve location based information and convey that to the service platform. In this alternative embodiment, steps 107 and 109 below would be eliminated.

If call treatment based on the called party's location is to be invoked in step 102, then a service platform is contacted in step 105 and the service platform receives the request in step 106. This service platform can also be, and may be referred to as, an application server or, in traditional telephony terms, a service control point working in conjunction with an interactive voice response (IVR) unit or an intelligent peripheral (IP) player, which is a media server. The application server alone or with other servers, hosts computer software that implements the present invention. If it is determined in step 107 that the functionality of the present invention is to be applied, then, in step 108, it is determined if the location based information is available. If not, the in step 109, the location information is obtained and in step 110, the application server determines the RBT content to be provided based on the options selected by the subscriber and based on the location of the called party. If, in step 108, it is determined that the location based information is available, then in step, the application server determines the RBT content to be provided based on the options selected by the subscriber and based on the location of the called party. In step 110, the application server, using software running thereon, correlates the location based data with content which corresponds to that location. In steps 111 and 112, the options selected by the subscriber, in conjunction with the location based data and available content, determine the RBT content to be provided to the calling party. More specifically, the service platform requests the MSC to connect the calling party to the media server. Based on the instruction from the application server-SCP, the media server plays the content assuming the media is voice. If the media is not voice, the media server interacts with the terminal to convey the content in a format acceptable to the calling party's terminal. The method then terminates at step 104.

The generalized method of the present invention includes the following steps: defining a set of rules for the treatment of a call based on options selected by the subscriber, allowing a subscriber of a terminal to associate the set of rules with their location, making location based data available to a service platform of a telecommunications system, accessing, by the service platform, RBT content based on the location of the called party, and handling the call in accordance with the rules selected to apply to the call.

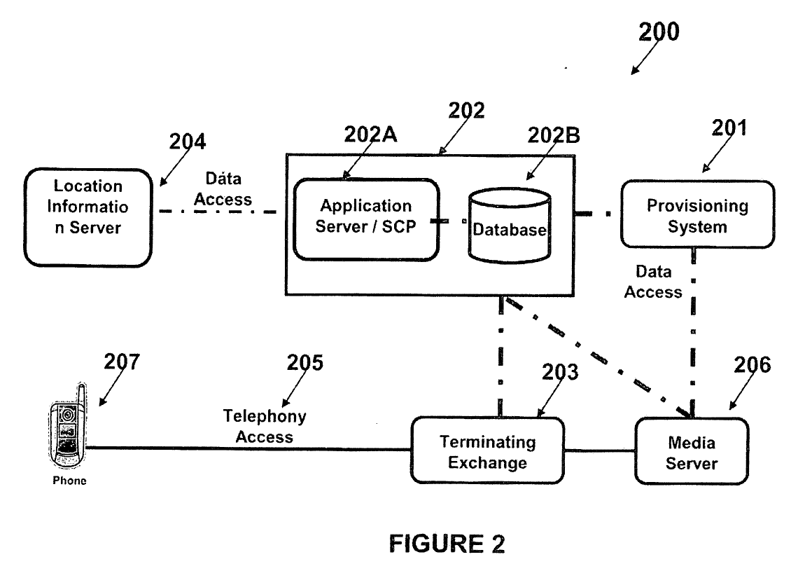

FIG. 2 is a block diagram of a system 200 that can be used to implement the present invention. As seen therein, the subscriber subscribes to the service provided by the present invention over a provisioning system 201. The provisioning system 201 is coupled to an application server/SCP/database 202 and a media server 206. If the subscriber has subscribed to the service, location based data from or related to the terminal is made available to the application server/SCP 202A. The application server/SCP 202A is a functional node of a telecommunications system and includes, but is not limited to, a service platform, an application server or service control point. Based on such location based data and rules stored in, and invoked from database 202B, RBT content is selected and provided to a calling party. In the present invention, the application server/SCP 202A has access to location based data from, e.g., a GPS within the terminal of the subscriber, or from other location based technology that is provided from a location information server 204. When a terminating exchange 203 queries the application server 202B, the application server/SCP 202A correlates the location based data with RBT content and the service platform or media server 206, based on instructions from the application server/SCP 202A provides such RBT content to the terminal 207 of the calling party over telephony access 205. Generally, the application server/SCP 202A and associated database 202B maintain the set of rules for the treatment of a call based on options selected by the subscriber, in addition to the location based data. Such application server/SCP 202A includes a computer program therein adapted to associate the set of rules with the location based data. A bus is adapted to make the location based data and associated rules available to the application server/SCP 202A from the database 202B.

The present invention can be maintained in a node for handling calls in a telecommunications system or distributed over several nodes, the nodes including at least a means for maintaining the set of rules for the treatment of a call and the means for associating the set of rules and the location based data with RBT content. Further, the present invention can be embodied in a computer program adapted to be loaded into at least one memory and executed by at least one processor, the program being adapted to accept location based data and correlate it with a set of rules selected by a subscriber and with location based RBT content to be provided to a calling party.

While particular embodiments of the present invention have been described, it is not intended that the present invention be limited thereto, as it is intended that the invention be as broad in scope as the art will allow and that the specification be read likewise. While the apparatus of the invention is shown in block diagram format, it will be appreciated that the block diagram may be representative of and implemented by hardware, software, firmware, or any combination thereof. Moreover, the functionality of certain aspects of the block diagram can be obtained by equivalent or suitable structure. It will therefore be appreciated by those skilled in the art that yet other modifications could be made to the provided invention without deviating from its spirit and scope as claimed.

What is claimed:

1. A method of providing ring back tone (RBT) content to a calling party, comprising the steps of:
obtaining location based data related to a terminal;
correlating the location based data to RBT content; and
providing the correlated RBT content to the calling party.

2. The method of claim 1, further comprising the step of applying rules selected by an RBT subscriber in connection with the provision of RBT content to a calling party.

3. The method of claim 1, wherein the RBT content is localized to the location of the called party.

4. The method of claim 1, wherein the RBT content is selected from the group consisting of: regional or local music, regional or local speech, regional or local news, regional or local events calendar, regional or local sports, regional or local weather, and regional or local time.

5. A method in a telecommunications system of providing notification to a calling party that a called party is being signaled, comprising the steps of:
sending a call set-up request to a first node;
determining whether RBT call treatment based on the called party's location is to be invoked;
if not, then processing the call in a conventional manner;
if RBT call treatment is to be based on the called party's location, then sending the call set-up request to a second node;
obtaining location based data related to the called party;
sending the location based data to the second node; and
determining, by the second node, RBT content to be provided based on options selected by the subscriber and the location based data.

6. The method of claim 5, wherein the first node is a mobile switching center (MSC) and the second node is a service platform.

7. The method of claim 6, wherein the service platform is one selected from the group consisting of an application server and associated database; a service control point working in conjunction with an interactive voice response (IVR) unit; a media server and an intelligent peripheral (IP) player.

8. The method of claim 5, further comprising modifying the RBT treatment provided to a calling party based on an option selected by a subscriber.

9. The method of claim 8, wherein the option selected by the subscriber is at least one of: selecting the type of RBT content; electing the callers to whom to play the RBT content; selecting the values appropriate to the identified location; selecting the RBT content based on the identification of the caller; and activating or deactivating the location based RBT treatment.

10. A method in a telecommunications system of providing notification to a calling party that a called party is being signaled, comprising the steps of:
sending a call set-up request to a mobile switching center (MSC);
determining, by an application server/SCP, whether RBT call treatment based on the called party's location is to be invoked;
if not, then processing the call in a conventional manner;
if RBT call treatment is to be based on the called party's location, then obtaining location based data related to the called party;
sending the location based data to the application server/SCP; and
determining, by the application server/SCP, RBT content to be provided based on options selected by the subscriber and the location based data.

11. A method of providing a ring back tone (RBT) to a calling party, comprising the steps of:
defining a set of rules for the treatment of a call based on options selected by a subscriber;
allowing the subscriber of a terminal to associate the set of rules with a location;
making location based data available to a service platform of a telecommunications system;
accessing, by the service platform, RBT content determined by the location of the called party, and
handling the call in accordance with the rules selected to apply to the call.

12. A system for providing location based ring back tone (RBT) treatment comprising:
a module for providing location based data from or related to a terminal;
an application server adapted to receive the location based data;
a media server for storing RBT content coupled to the application server; and
the application server adapted to correlate the location based data and the RBT content.

13. The system of claim 12, wherein the module for providing location based data is a global positioning system (GPS) unit.

14. The system of claim 12, further comprising a terminating exchange adapted to query whether a location based RBT service has been activated.

15. The system of claim 12, further comprising a database coupled to the application server for storing rules based on options selected by a subscriber.

16. The system of claim 12, further comprising a provisioning system adapted to permit a subscriber to subscribe to location based RBT treatment.

17. The system of claim 16, wherein the provisioning system coupled to an application server/application database and a media server.

18. The system of claim 12, wherein the RBT content is media content from the group consisting of at least: regional or local music, regional or local speech, regional or local news, regional or local events calendar, regional or local sports, regional or local weather, and regional or local time.

19. A node for handling calls in a telecommunications system, comprising
means for maintaining the set of rules for the treatment of a call; and
means for associating the set of rules and location based data with RBT content.

20. Computer program code embodied on a computer readable medium and adapted to be loaded into at least one memory and executed by at least one processor, the program being adapted to accept location based data and correlate it with a set of rules selected by a subscriber and with location based RBT content to be provided to a calling party.
